(19) United States
(12) Patent Application Publication
(10) Pub. No.: US 2024/0236391 A9
(43) Pub. Date: Jul. 11, 2024

(54) INFORMATION PROCESSING DEVICE, INFORMATION PROCESSING METHOD, AND STORAGE MEDIUM STORING PROGRAM

(71) Applicant: 17LIVE Japan Inc., Tokyo (JP)

(72) Inventors: Yung-Chi HSU, Taipei City (TW); Chia-Han CHANG, Taipei City (TW); Chen-Hai TENG, Taipei City (TW)

(21) Appl. No.: 18/485,063

(22) Filed: Oct. 11, 2023

(30) Foreign Application Priority Data
Oct. 24, 2022 (TW) 111140319
Mar. 9, 2023 (JP) 2023-036501

(51) Int. Cl. H04N 21/254; G06Q 30/0202; G06Q 30/0207; G06Q 30/0211; H04N 21/2187; H04N 21/442

(52) U.S. Cl. CPC H04N 21/2542; G06Q 30/0202; G06Q 30/0211; G06Q 30/0239; H04N 21/2187; H04N 21/44204

(57) ABSTRACT

An information processing method of the present disclosure includes: via one or more computer processors, receiving data relating to live sales performed by a livestreamer via live video streaming; inputting the data into a machine learning model; and based on a result generated by the machine learning model, obtaining promotional information that is useful for the livestreamer to perform the live sales.

### CROSS-REFERENCE TO RELATED APPLICATIONS

This application is based on and claims the benefit of priority from Taiwanese Patent Application Serial No. 111140319 (filed on Oct. 24, 2022) and Japanese Patent Application Serial No. 2023-036501 (filed on Mar. 9, 2023), the contents of which are hereby incorporated by reference in its entirety.

### TECHNICAL FIELD

The present disclosure relates to an information processing device, an information processing method, and a storage medium storing a program for livestreaming an online sales or the like.

### BACKGROUND

With the development of technology, the mode of information exchange has changed. In the Showa period (1926-1989), one-way information communication such as newspapers and television was the main stream. In the Heisei period (1990-2019), with the widespread availability of cell phones and computers and the significant improvement in Internet communication speed, real-time interactive communication services such as chat services emerged, and distribution services such as movies on demand also became popular as storage costs were reduced. And nowadays, with the sophistication of smartphones and further improvements in network speed as typified by 5G, services that enable real-time communication through video, especially livestreaming services, are rapidly gaining recognition. The livestreaming services allow people to share fun moments even when they are in separate locations from each other and so the number of users, especially young people, is expanding.

Livestreaming has been used for online sales, where a livestreamer introduces products to viewers via livestreaming and cooperates with a shopping interface of the viewers' devices, allowing the viewers to shop and complete shopping during the livestream (see, for example, United States Patent Application Publication No. 2022/0191594 and International Publication No. WO 2021/106034). For the viewers, who are also consumers, their shopping needs can be satisfied in real time on the online sales through the livestreaming rather than online sales through web pages, which lack real-time interaction between sellers and consumers, so the online sales through livestreaming have a more favorable sales volume than the online sales through web pages. Meanwhile, the number of people who wish to live-stream product sales or view such livestreams has continued to increase recently due to the COVID-19 situation.

### SUMMARY

In product sales, sales strategy is one of the important factors that affects sales volume or sales. Especially in livestreaming commerce, where two-way communication between the livestreamer and viewers is performed, the choice of sales strategy and the timing of the choice have a significant impact on the number of items sold and sales volume. However, in a conventional livestream for selling products in which multiple viewers participate, sales strategies are often determined subjectively and solely by the livestreamer, making it impossible to effectively optimize sales strategies that emphasize the achievement of goals. One object of the disclosure is to provide a technique for optimizing the sales strategy in product sales through livestreaming performed by a livestreamer.

Other challenges and objects of the invention disclosed in this specification will be apparent with reference to the entire description in this specification. One or more aspects of the invention disclosed herein may solve a challenge that will be apparent with reference to the entire specification.

One aspect of the disclosure provides an information processing method. The method includes: via one or more computer processors, receiving data relating to live sales performed by a livestreamer via live video streaming; inputting the data into a machine learning model; and based on a result generated by the machine learning model, obtaining promotional information that is useful for the livestreamer to perform the live sales.

Another aspect of the disclosure provides an information processing device. The information processing device includes: a processor; and a storage adapted to store executable commands. Once the executable commands are executed, the device causes the processor to perform a step of: receiving data relating to live sales performed by a livestreamer via live video streaming; inputting the data into a machine learning model; and based on a result generated by the machine learning model, obtaining promotional information that is useful for the livestreamer to perform the live sales.

Another aspect of the invention provides an information processing device including: a receiving unit adapted to receive data relating to live sales performed by a livestreamer via live video streaming; a processing unit adapted to apply the data to a machine learning algorithm; an advice generation unit adapted to generate, based on a result of processing the machine learning algorithm, advice that is useful for the livestreamer to perform the live sales.

Yet another aspect of the disclosure provides a non-transitory computer-readable storage medium storing a program. The program causes one or more computer devices to perform the steps of: receiving data relating to live sales performed by a livestreamer via live video streaming; inputting the data into a machine learning model; and based on a result generated by the machine learning model, obtaining promotional information that is useful for the livestreamer to perform the live sales.

It should be noted that the components described throughout the disclosure and of the embodiments may be interchanged or combined. The components and features described above may be be replaced by devices, methods, systems, computer programs, recording media containing computer programs, etc. expressed under the embodiments. Any such modifications are intended to be included within the spirit and scope of the present disclosure.

### Advantageous Effects

According to the aspects of the disclosure, it is possible to optimize the sales results by predicting the sales of a selling item sold in the livestream based on the parameters relating to to the livestream using a machine learning model, and by guiding the livestreamer who is demonstrating the selling item based on the predicted results to change his/her way to sell the item.

### BRIEF DESCRIPTION OF THE DRAWINGS

FIG. 1 schematically illustrates a configuration of a livestreaming system according to embodiments of the present disclosure.

FIG. 2 is a block diagram showing functions and configuration of the livestreaming system of FIG. 1.

FIG. 3A schematically illustrates a trend of the number or amount of items sold over time.

FIG. 3B schematically illustrates a trend of the number or amount of items sold over time.

FIG. 4 schematically illustrates execution of an information processing method according to one embodiment of the disclosure.

FIG. 5 is a representative screen image of a livestream displayed on a display of a livestreamer's user terminal.

FIG. 6 schematically illustrates execution of an information processing method according to another embodiment of the disclosure.

FIG. 7 schematically illustrates a model of the embodiment of FIG. 6.

FIG. 8 schematically illustrates a training stage of a machine learning model in one embodiment of the disclosure.

FIG. 9 schematically illustrates a deployment stage of the machine learning model in one embodiment of the disclosure.

FIG. 10 schematically illustrates execution of a method according to another embodiment of the disclosure.

FIG. 11 shows sales volume forecasts in the embodiment of FIG. 10.

FIG. 12 is a representative screen image of a livestream displayed on the display of the livestreamer's user terminal.

### DESCRIPTION OF THE EMBODIMENTS

Various embodiments disclosed herein (hereinafter also referred to as “the present invention”) will be described hereinafter with reference to the appended drawings. For purposes of clarity and brevity, the same or like elements, components, processes and signals throughout the Figures are labeled with same or similar designations and numbering, and those descriptions will be not repeated. Also, some of the components that are less related and thus not described are not shown in the figures. The terms “live video streaming” and “livestreaming” are herein used interchangeably, but both refer to broadcasting of real-time videos over a network.

The following embodiments of the present disclosure do not limit the scope of the claims. The elements included in the following embodiments are not necessarily essential to solve the problem addressed by the invention.

The procedures described herein, particularly those described with a flow diagram or a flowchart, are susceptible of omission of part of the steps constituting the procedure, adding steps not explicitly included in the steps constituting the procedure, and/or reordering the steps. The procedure subjected to such omission, addition, or reordering is also included in the scope of the present disclosure unless diverged from the purport of the present disclosure.

The present disclosure relates to a method of generating, based on a machine learning model, sales promotion information that can be used to help a livestreamer with product sales through a live video streaming in a livestreaming system. The product sales can be optimized by dynamically adjusting a sales strategy in real time depending on different goals, such as achieving maximum product sales volume or maximum profit within a minimum time when the livestreamer sells products live to a large number of viewers.

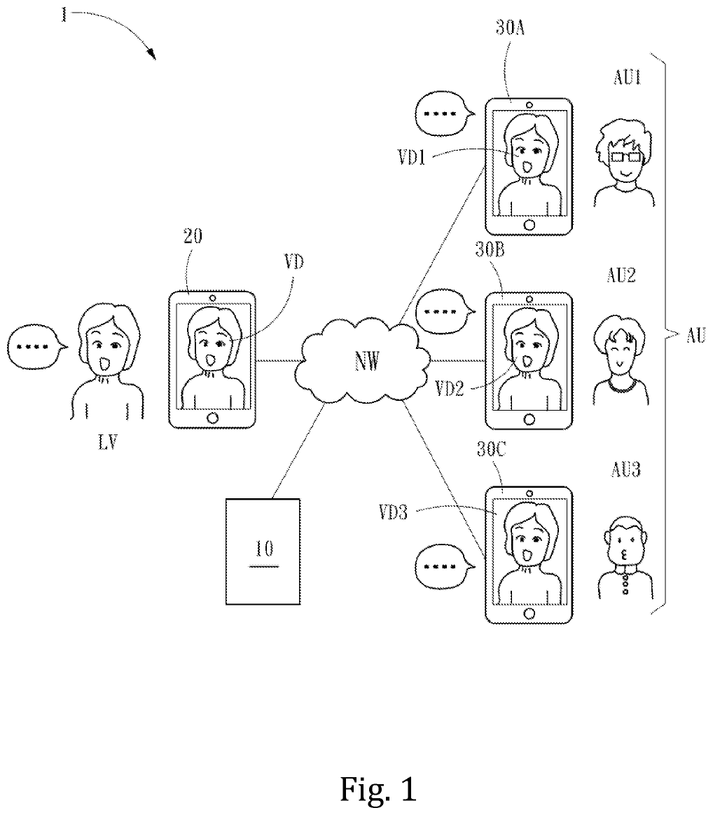

FIG. 1 schematically illustrates a configuration of a livestreaming system 1 according to embodiments of the present disclosure. The livestreaming system 1 provides an interactive livestreaming service that allows a livestreamer LV (also referred to as a live broadcaster, host, or streamer) and audiences AU (also referred to as viewers) (AU1, AU2 . . . ) to communicate in real time. As shown in FIG. 1, the livestreaming system 1 includes a server 10, a user terminal 20 of the livestreamer, and user terminals 30 (30A, 30B . . . ) of the viewers. The livestreamer and viewers may be collectively referred to as users. The server 10 may be one or more information processing devices connected to a network NW. The user terminals 20 and 30 may be, for example, mobile terminal devices such as smartphones, tablets, portable PCs, recorders, portable gaming devices, and wearable devices, or may be stationary devices such as desktop PCs. The server 10, the user terminal 20, and the user terminals 30 are interconnected so as to be able to communicate with each other over various wired or wireless network NW

The livestreamer LV, the viewers AU, and an administrator (not shown) who manages the server 10 participate in the livestreaming system 1. The livestreamer LV is a person who records contents with his/her user terminal 20 and broadcasts the contents in real time by uploading the data directly to the server 10. In this embodiment, the livestreamer LV sells selling items to the viewers AU via livestreaming. Such livestreams may be referred to as live-commerce type livestreams. The administrator provides a platform for live-streaming contents on the server 10, and also mediates or manages real-time interactions between the livestreamer LV and the viewers AU. The viewers AU access the platform at their user terminals 30 to select and view desired contents. During livestreaming of the contents, the viewers AU can operate their user terminals 30 to exchange message and/or video/audio with the livestreamer LV.

As used herein, the term “livestreaming” or “live-streaming” may mean a mode of data transmission that allows a content recorded at the user terminal 20 of the livestreamer LV to be reproduced or played and viewed at the user terminals AU of the viewers substantially in real time, or it may mean streaming itself realized by such a mode of transmission. The livestreaming may be achieved using existing livestreaming technologies such as HTTP Live Streaming, Common Media Application Format, Web Real-Time Communications, Real Time Messaging Protocol and MPEG DASH. The livestreaming includes a transmission mode that allows the viewers AU to delay the scheduled time to view the contents when the livestreamer LV records the contents. As for the length of the delay, it may be acceptable for a delay even with which interaction between the livestreamer LV and the viewers AU can be established. The livestreaming is different from a so-called on-demand video streaming. In the on-demand video streaming, data of the entire recorded contents is temporarily stored on the server, and at any subsequent time, the data is provided to the user from the server upon the user's request.

The term “video data” herein refers to data that includes image data (also referred to as visual data) generated using an image capturing function of the user terminals 20 and 30 and voice and sound data (also referred to as audio data) generated using an audio input function of the user terminals 20 and 30. The video data is reproduced at the user terminals 20 and 30, so that the users can view the contents. In the embodiments, it is assumed that between video data generation at the user terminal 20 of the livestreamer LV and video data reproduction at the user terminal 30 of the viewer AU, performed is processing to change format, size, or specifications of the data, such as compression, decompression, encoding, decoding, or transcoding. However, the content (e.g., video and audio) represented by the video data before and after such processing does not substantially change. So in the embodiment, the video data after such processing is herein described as the same as the video data before such processing. In other words, when video data is generated at the user terminal 20 of the livestreamer LV and then reproduced at the user terminal 30 of the viewer AU via the server 10, the video data generated at the user terminal 20 of the livestreamer LV, the video data that passes through the server 10, and the video data received and reproduced at the user terminal 30 of the viewer AU are herein considered as all the same video data.

In the example shown in FIG. 1, the livestreamer LV livestreams the screen. The user terminal 20 of the livestreamer LV generates video data by recording images and sounds of the livestreamer LV who is performing a live commerce, and the generated data is transmitted to the server 10 over the network NW. The user terminal 20 displays the recorded video image VD of the livestreamer LV on the display of the user terminal 20 to allow the livestreamer LV to check the content that is to be streamed.

The user terminals 30A and 30B of the viewers AU1 and AU2 respectively, who have requested the platform to enable them to view the livestream of the livestreamer LV, receive video data related to the livestream over the network NW and reproduce the received video data, to display video images VD1 and VD2 on their displays and output audio through the speakers. The video images VD1 and VD2 displayed at the user terminals 30A and 30B, respectively, are substantially the same as the video image VD captured by the user terminal 20 of the livestreamer LV, and the audio outputted at the user terminals 30A and 30B is substantially the same as the audio recorded by the user terminal 20 of the livestreamer LV.

Recording of images and sounds at the user terminal 20 of the livestreamer LV and reproduction of the video data at the user terminals 30A and 30B of the viewers AU1 and AU2 are performed substantially simultaneously. When the viewer AU1 enter a message at the user terminal 30A in the livestream in which viewers can send messages, the server 10 displays the comment on the user terminal 20 of the livestreamer LV in real time and also displays the comment on the user terminals 30A and 30B of the viewers AU1 and AU2, respectively. When the livestreamer LV reads the message and develops his/her talk to cover and respond the content of the message, the video VD and sound of the talk are displayed on the user terminals 30A and 30B of the viewers AU1 and AU2, respectively. This interactive action is recognized as establishment of a conversation between the livestreamer LV and the viewer AU1. In this way, the livestreaming system 1 realizes the livestreaming that enables the interactive communication, not one-way communication.

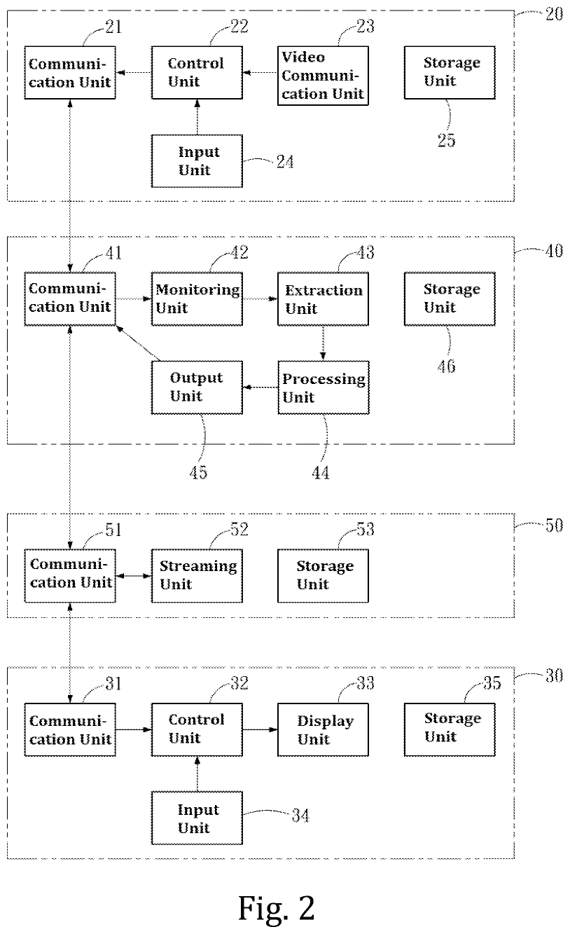

FIG. 2 is a block diagram showing functions and configuration of the livestreaming system 1 of FIG. 1. The user terminals 20 and user terminal 30 may have the same functions and configuration. The blocks in FIG. 2 and the subsequent block diagrams may be executed by elements such as a computer CPU or a mechanical device in terms of hardware, and can be executed by a computer program or the like in terms of software. The blocks shown in the drawings are, however, functional blocks realized by cooperative operation between such hardware and software. Therefore, it is understood by those skilled in the art that these functional blocks can be realized in various forms by combining hardware and software.

The livestreaming system 1 of FIG. 2 includes the user terminal 20 of the livestreamer LV, a server 40 on the livestreamer LV side, a server 50 on the viewer AU side, and the user terminals 30 on the viewer AU side. The user terminal 20 of the livestreamer LV includes a communication unit 21, a control unit 22, a video communication unit 23, an input unit 24, and a storage unit 25. The server 40 on the livestreamer LV includes a communication unit 41, a monitoring unit 42, an extraction unit 43, a processing unit 44, an output unit 45, and a memory unit 46. The server 50 on the viewer AU side includes a communication unit 51, a livestreaming unit 52, and a processing unit 53. The user terminal 30 on the viewer AU side includes a communication unit 31, a control unit 32, a display unit 33, an input unit 34, and a storage unit 35.

The communication unit 21 is configured to be communicatively connected to the server 40 on the livestreamer LV side, the server 50 on the viewer AU side, the user terminal 30 on the viewer AU side or any other external device over the network NW and to transmit video (or still images) of the livestreamer LV to the server 40 on the livestreamer LV side and/or the server 50 on the viewer AU side. The control unit 22 generates a video of the livestreamer LV and a video that is transmitted to the livestreamer LV according to an instruction inputted through the input unit 24. The video communication unit 23 takes video (or even still images) to be streamed. The input unit 24 receives commands or information inputted by the user (i.e., livestreamer LV). The storage unit 25 is used to store various data and programs.

The communication unit 41 is connected to the user terminal 20 of the livestreamer LV, the server 50 on the viewer AU side, the user terminal 30 on the viewer AU side or any other external devices over the network NW. The monitoring unit 42 monitors comments or messages posted for the video (or still images) by users other than the livestreamer LV. The extraction unit 43 extracts or scouts specific keywords related to product sales or orders from the comments or messages monitored by the monitoring unit 42. The processing unit 44 performs processing related to product sales or orders of a product(s). The output unit 45 outputs information about product sales or orders to be displayed on the user terminal 30 on the viewer AU side. The storage unit 46 is used to store various data and programs.

The communication unit 51 is connected to the user terminal 20 of the livestreamer LV, the server 30 on the viewer AU side, the server 40 on the livestreamer LV side or any other external devices over the network NW. The livestreaming unit 52 delivers the video (or still images) received from the user terminal 20 of the livestreamer LV to the user terminal 30 of the viewer AU.

The storage unit 35 is used to store various data and programs. The communication unit 31 is configured to communicate with the user terminal 20 of the livestreamer LV, the server 40 on the livestreamer LV side, the server 50 on the viewer AU side or any other external device over the network NW, and to receive a video and send commands or comments to the server 50 on the viewer AU side. The processing unit 32 performs processing related to product sales or orders of a selling item(s). The display unit 33 displays the video distributed by the server 50 on the viewer AU side. The input unit 34 receives commands or information input (e.g., comments or messages on the video) from the user (i.e., viewer AU).

The livestreamer LV and the viewers AU download and install a livestreaming application according to the embodiment (hereinafter referred to as a livestreaming application), onto the user terminals 20 and 30 from a download site over the network NW. Alternatively, the livestreaming application may be pre-installed on the user terminals 20 and 30. When the livestreaming application is executed on the user terminals 20 and 30, the user terminals 20 and 30 communicate with the server 10 over the network NW to implement various functions. These functions are realized in practice by the livestreaming application on the user terminals 20 and 30. In any other embodiments, these functions may be realized by a computer program that is written in a programming language such as HTML (HyperText Markup Language), transmitted from the server 10 to web browsers of the user terminals 20 and 30 over the network NW, and executed by the web browsers.

The aforementioned livestreaming system 1 is used to perform the following information processing method in one embodiment disclosed in the present application.

Step 1: Receive, via a processor of one or more computer devices, data related to live commerce performed by the livestreamer LV through live video streaming.

Step 2: Input data into a machine learning model.

Step 3: Based on results generated by the machine learning model, obtain promotional information that is useful for the livestreamer LV to perform the live sales.

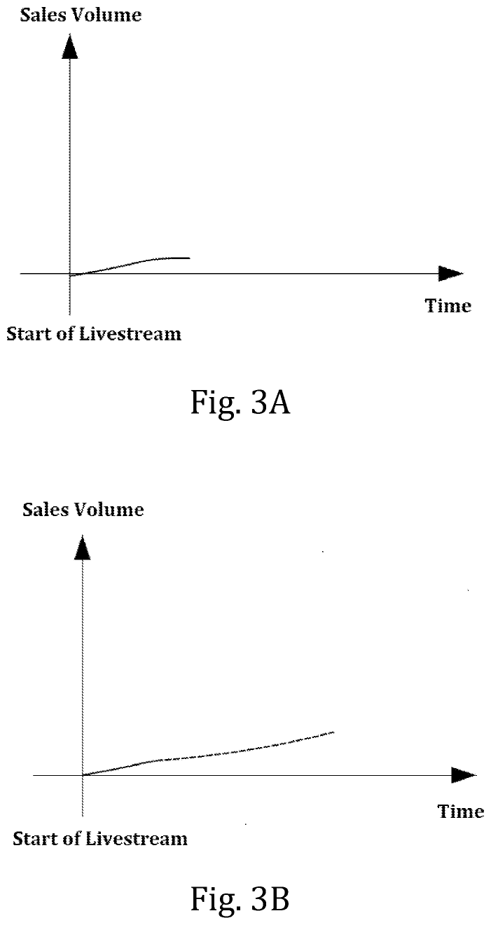

FIGS. 3A and 3B illustrate the challenges in conventional sales. The solid line shows a trend of sales volume over time without sales promotion, while the dashed line in FIG. 3B shows a trend of sales volume after adopting a certain sales promotion method or changing the sales strategy. In a conventional livestream e-commerce, it is not possible to know whether the adopted sales promotion method or sales strategy is the optimal strategy (e.g., the strategy that can yield the largest profit). The present disclosure improves the sales situation by using prediction results obtained through a machine learning model to guide and assist the livestreamer LV to demonstrate selling items or change sales strategies during the livestreams.

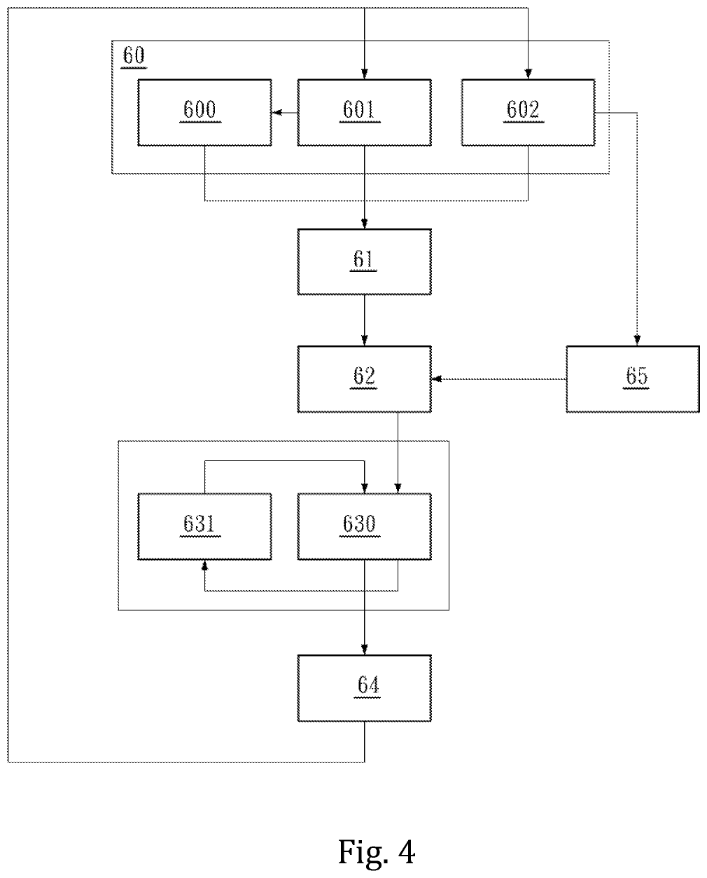

In the method of the disclosure, the computer device may be the server 40 on the livestreamer LV side. FIG. 4 schematically illustrates execution of the method according to one embodiment of the disclosure. In block 60 in FIG. 4, possible sources for obtaining data, e.g., a monitoring unit 600 and at least one of service traffic record 601 or user record 602 are included. In one embodiment, the data is data relating to live sales performed by a livestreamer via live video streaming, such as an attribute(s) of a sold or unsold selling item(s), the number of sold or unsold selling items, the price(s) of sold or unsold item(s), the number of views, a viewer attribute(s), a viewer behavior score(s), a viewer behavior history, viewer metadata, service traffic, the elapsed time (duration), the remaining time (duration), or the current time (time), in one or more combinations.

In block 61, data for each source has been collected, and these collected data are inputted into the machine learning model (block 62). The machine learning model uses an algorithm(s) to compute these data to generate results. The results generated by the machine learning model are further used to generate promotional information that is useful for the livestreamer LV to sell live.

In the disclosure, the machine learning model predicts and provides promotional information based on the data relating to live sales via live video streaming of the livestreamer LV. The machine learning model may learn or be trained based on actual sales data with or without promotions, or all actual sales data (with and without promotions).

Depending on different implementations or sales goals, the promotional information may be future sales forecasts generated based on an unchanged sales strategy, i.e., future sales forecasts based on a traditional sales strategy (with or without promotion), or the promotional information may include multiple future sales plans (e.g., different promotion methods or different sales targets) and multiple sales forecasts corresponding to the multiple future sales plans. The sales forecasts may be the amount of sold items or profit at a specific time, may be the projected time when all the selling items will be sold out. Or the sales forecasts may be the sales pace or gross profit value within a specific period.

In the embodiment, the promotional information is a sales plan that includes a recommended activity, and the results generated by the machine learning model may be assessment results (block 630), e.g., a sales forecast obtained based on the results of the livestreaming sales of the livestreamer LV, where the sales forecasts may be expressed as scores.

Furthermore, based on the obtained evaluation, a library (e.g., a look-up table that is preloaded or generated in real time) (block 631) is used to obtain recommended activity (i.e., promotional information) (block 64) regarding the evaluation. Table 1 below shows an example.

TABLE 1

| Range of | Recommended | Degree of Need | Level of |
|---|---|---|---|
| Rating | Action | for Promotion | Promotion |
| 0~0.3 | A | Low | Low |
| 0.3~0.6 | B | Moderate | Moderate |
| 0.6~1.0 | C | High | High |

When the rating generated by the machine learning model is between 0 and 0.3, the recommended activity obtained is A. When the rating generated by the machine learning model is between 0.3 and 0.6, the recommended activity obtained is B. When the rating generated by the machine learning model is between 0.6 and 1.0, the recommended activity is C. As an example, the high and low ratings described above can reflect the degree to which an aggressive sales promotion strategy is currently needed; the lower the rating, the less aggressive sales promotion is needed, and conversely, the higher the rating, the more aggressive sales promotion is needed. For example, the recommended activity A requires no promotion activity, the recommended activity B employs a conventional promotion activity, and the recommended activity C employs an aggressive promotion activity. The content of the promotion activity may include, for example, a discount rate, an item(s) discounted, the number of discounted items, a duration of discount, the time of discount, a target that receives discount, provision of discount coupons, membership, provision of bonus (e.g., buy one, get one free), provision of product gifts, etc.

In one example, after the livestreamer LV receives the promotional information, the promotional information or machine learning model may be further evaluated against the activity performed and result obtained. The method described above may further include the following steps.

Step 4: After providing the promotional information, further determine whether the livestreamer LV's subsequent sales activity matches the promotional information.

Step 5: Based on first sales data before the livestreamer LV receives the promotional information and second sales data after the livestreamer LV receives the promotional information, generate an evaluation for the promotional information or the machine learning model, including whether the sales action matches the promotional information.

Similarly, referring to FIG. 4, the promotional information in block 64 is fed back to the block 61, included as a part of the data, and inputted into the machine learning model to perform computing (block 65). The result of the feedback analysis can be used as an additional assessment, i.e., the promotional information generated by the machine learning model is further assessed in terms of its usefulness in actual sales based on the additional assessment. The first sales data is the sales data before the livestreamer LV receives the promotional information and the second sales data is the sales data after the livestreamer LV receives the promotional information. The feedback analysis is performed by scouting whether the livestreamer LV employs the promotional information to promote the sales and comparing the first sales data with the second sales data to evaluate the promotional information or the machine learning model. In one example, the sales data may be sales pace or gross profit. The assessment may be used to continuously train and advance the machine learning model. In some embodiments, the machine learning model may include a reinforcement learning model.

To give an example, Table 2 shows several possible situation. When the livestreamer LV adopts the promotional information, assume that the second sales data includes a better sales result than the first sales data and give a positive rating to the promotional information (or the machine learning model), or assume that the second sales data has an inferior sales result than the first sales data and give a neutral rating to the promotional information (or the machine learning model). When the livestreamer LV does not adopt the promotional information, assume that the second sales data includes a better sales result than the first sales data, and give a negative rating to the promotional information (or the machine learning model), or assume that the second sales data includes an inferior sales result than the first sales data, and give a neutral rating to the promotional information (or the machine learning model).

TABLE 2

| Did livestreamer | Did sales data improve | |
|---|---|---|
| LV adopt promotional | after adoption of | Additional |
| information? | promotional information? | Assessment |
| Yes | Yes | + |
| Yes | No | 0 |
| No | Yes | − |
| No | No | 0 |

In terms of the recommended activities, to give an example, assume that the initial number of selling items is 100, the selling items are one type, the selling price of the item is 50 yuan, the cost is 30 yuan per item, the profit is 20 yuan per item, and the sales volume in the first five minutes is 0. The parameters employed in the prediction are the attributes of the selling item, the number of inventory, the number of views, and the elapsed time (duration) or progress time (time). The machine learning model can provide the recommended activities at different subsequent times depending on the above conditions and parameters, as shown in Table 3.

TABLE 3

| Time | Recommended Action |
|---|---|
| First 5 to 10 minutes | 30% discount on previous |
| | 20 items for 5 minutes only |
| First 10 to 20 minutes | Stop special price offer and provide a 10% |
| | discount coupon to previous 30 viewers who |
| | participated in livestream during this period |
| First 20 to 30 minutes | Stop providing all special offers |

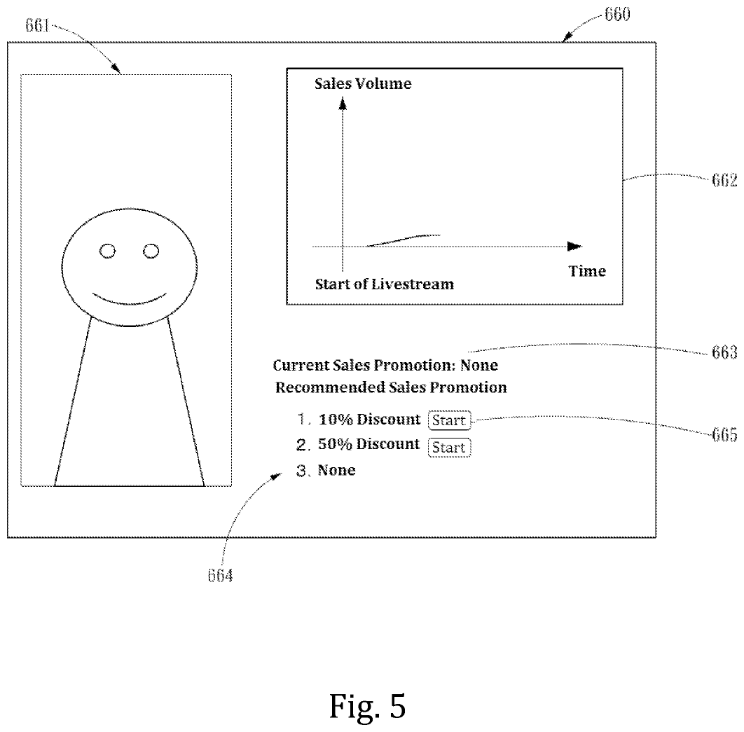

FIG. 5 shows a representative screen image 660 of a screen of a livestream on the display of the livestreamer LV's user terminal 20. The screen image 660 includes a screen 661 showing the livestream of the livestreamer LV, current sales data 662 (e.g., sales volume or sales pace), current sales promotion content 663, and sales promotion activities 664 provided via the above method. In one example, not just one promotion activity but multiple promotion activities 664 may be provided as shown in FIG. 5. The representative screen image 660 includes buttons 665 to initiate the corresponding promotion activity. In response to clicking on one of the buttons by the livestreamer LV, the corresponding promotion activity is initiated.

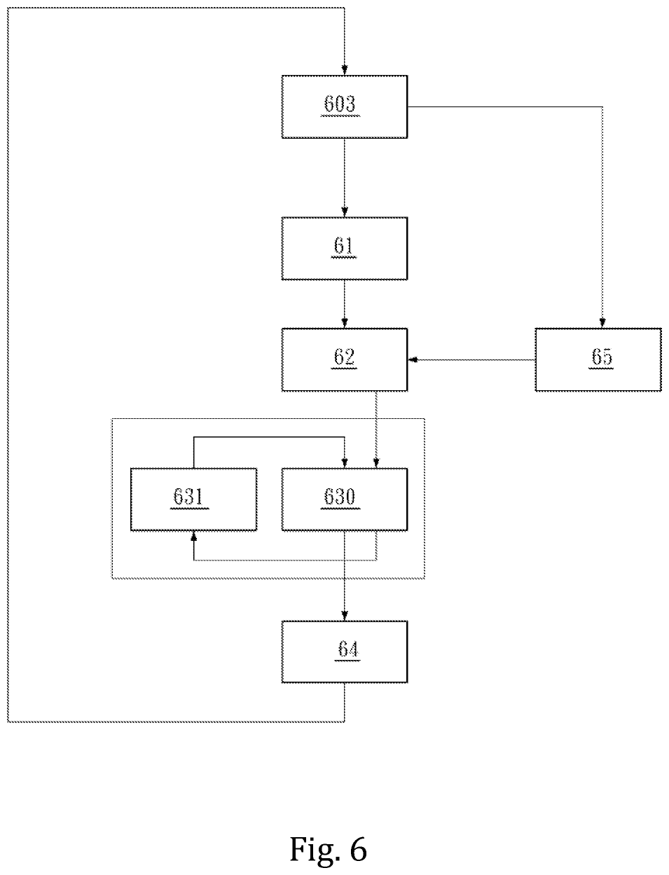

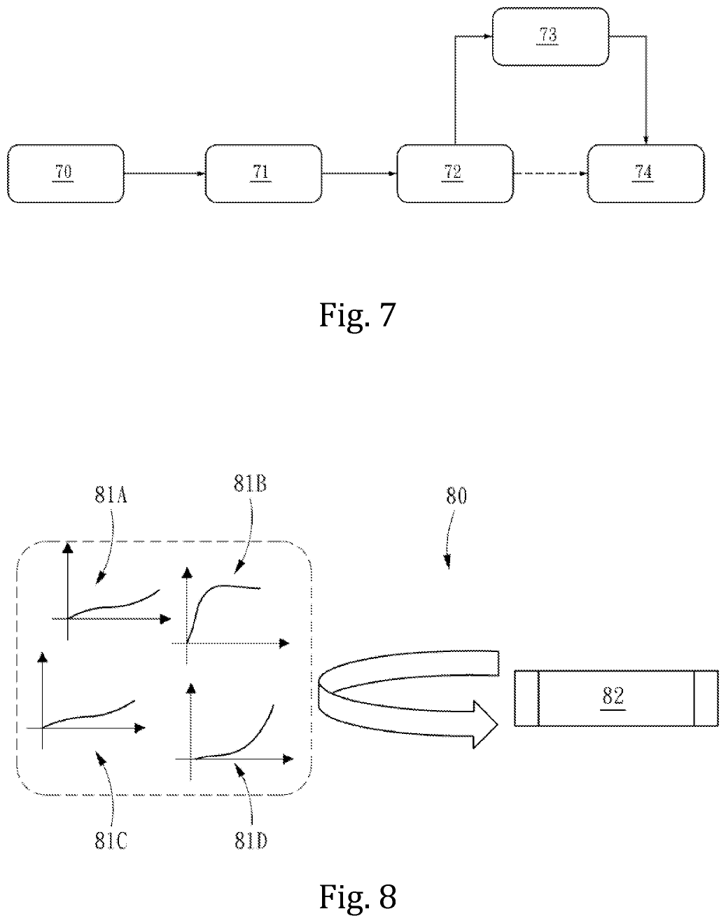

In one embodiment of the disclosure, the machine learning model may specifically assess sales forecasts in terms of the behavior or action of the viewer AU. FIG. 6 shows a schematic diagram of conducting such a method in this embodiment. This embodiment differs from the embodiment of FIG. 4 in that it employs behavior and/or data (block 603) of the viewer AU with respect to the data. FIG. 7 is a model schematic diagram of the embodiment, where block 71 shows a viewer behavior score calculation unit. A current viewer score 72 can be obtained by inputting, into a score calculation unit 71, parameters about the viewer AU such as the viewer's attribute(s), the viewer behavior score, the viewer behavior history, the viewer metadata, etc. The current viewer score 72 may be a single score reflecting the entire current viewers or multiple scores reflecting each current viewer. The current viewer score 72 can then be inputted into the machine learning model 73 to make deeper predictions about the promotional information.

For example, some viewers are less affected by the sales promotion (discounts, for example), and if such viewers are the majority, it can be predicted that providing the sales promotion is not an effective choice as the promotional information. Thus, obtain the extent to which the viewers are affected by the discount, and a prediction result (block 74) from the machine learning model 73 can be displayed on the display of the user terminal 20 of the livestreamer LV depending on the extent. When the prediction result indicates a high probability of improving the final profit without providing a promotional offer, the prediction result or recommended activity displayed instructs not to provide the promotional offer to the viewers. Whereas when the prediction result indicates a low probability of improving the final profit without providing the promotional offer, the prediction result or recommended activity displayed instructs to provide the promotional offer to the viewers, and further informs the livestreamer LV of the time to provide the promotional offer and how much discount the livestreamer should provide.

FIG. 8 illustrates a training stage 80 of the machine learning model in one embodiment of the disclosure, where the embodiment uses a plurality of pieces of actual sales data 81A, 81B, 81C, and 81D without sales promotions to train the machine learning model 82. For each of the actual sales data 81A, 81B, 81C, and 81D, the vertical axis represents the number of selling items and the horizontal axis represents the time (schematically shown). In the training of the machine learning model, more parameters may be introduced, e.g., the total number of viewers at a different time, number of new viewers at a different time, selling item attribute(s), manufacturer of the selling item, price of the selling item, livestreamer (livestreamer LV), attribute(s) of the livestreamer (livestreamer LV), store, coupon availability, coupon content, etc.

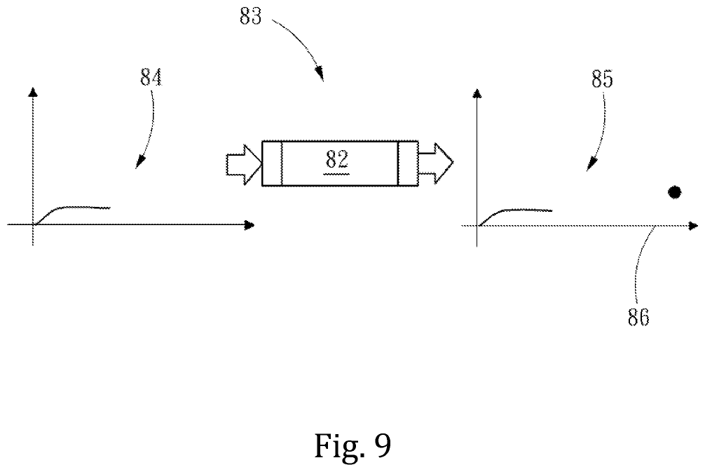

FIG. 9 schematically illustrates a deployment stage 83 of the machine learning model in one embodiment of the disclosure. The trained machine learning model 82 predicts subsequent sales 85 based on data 84 of the sales which the livestreamer LV has already performed via live video streaming (e.g., sales data from the previous 5 minutes), for example, the expected time 86 when all the selling items are sold out or the number of sold items at a future time. In the embodiment of FIG. 9, the machine learning model 82 may employ supervised learning.

In other embodiments, generation of the promotional information further includes the following steps.

Step 6: Input the data into the machine learning model to obtain two or more future sales plans and two or more sales forecasts corresponding to the future sales plans.

Step 7: Calculate the sales forecasts and obtain two or more projected sales profits corresponding to the sales plans.

Step 8: Deliver the future sales plan and projected sales profits to the livestreamer, and provide an interface that allows the livestreamer to select one of the multiple future sales plans to initiate the selected sales plan.

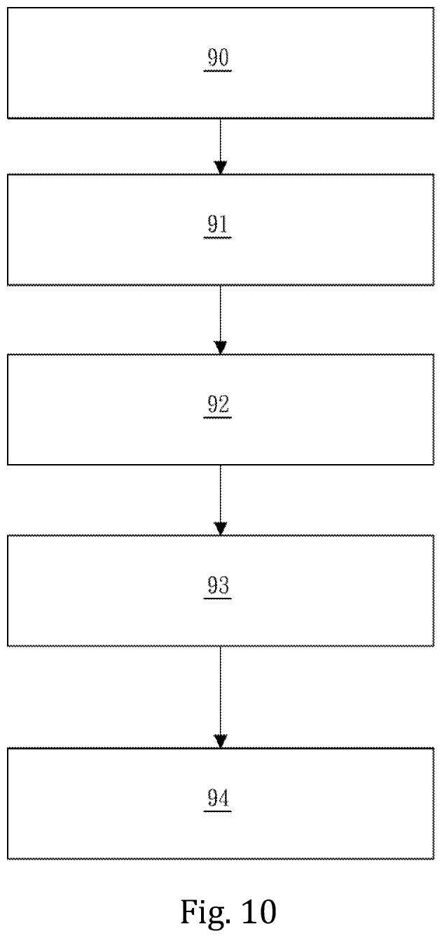

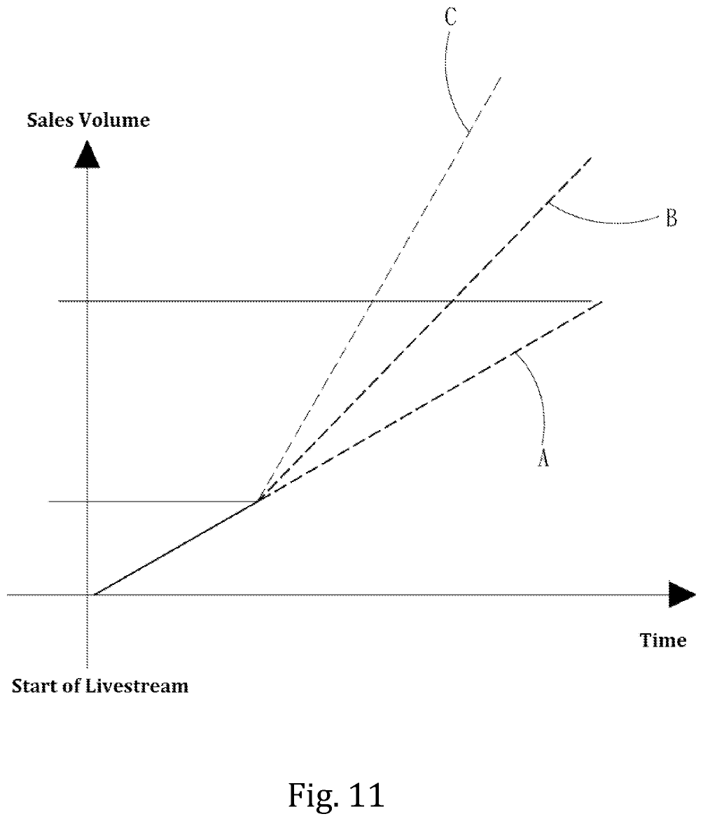

FIGS. 10 and 11 illustrate the above method, and FIG. 10 shows a flowchart of one embodiment of the disclosure. For example, the selling items in this example are one type, the selling price of the item is 50 yuan, the cost is 20 yuan, the profit is 30 yuan, and the number of the items sold in the previous 5 minutes is 10. In operation 90, the data is first inputted into the machine learning model 82 to obtain a prediction of the final sales volume (i.e., the amount or number of items sold at the end of the livestream) when no sales promotion is employed, e.g., the number of sold items is 30 units.

Next, two or more future sales plans and two or more sales forecasts corresponding to the two or more different future sales plans are computed (operation 91). As shown in Table 4 below, the sales forecasts here are profit forecasts, but after adopting the sales promotion, the projected final sales volume will correspondingly change. In case B, after adopting a 10% discount, the projected subsequent sales volume improves by 10%, thus increasing the projected final sales volume at the end of the livestream to 32 units. In case C, after adopting a 50% discount, the projected subsequent sales volume is improved by 50%, and thus the projected final sales volume at the end of the livestream is increased to 40 units. Note that for fairness, we assume that after the promotion is adopted, the discount is retroactive to the previously sold items.

TABLE 4

| | Projected | | |
|---|---|---|---|
| | Final Sales | | |
| Case | Volume | Future Sales Plan | Projected Sales Profit |
| A | 30 | Not adopt sales | 900 yuan (30 × 30) |
| | | promotion | |
| B | 30 | Provide 10% discount | 800 yuan (10 + 20 × 1.1) × 25 |
| C | 30 | Provide 50% discount | 300 yuan (10 + 20 × 1.5) × 5 |

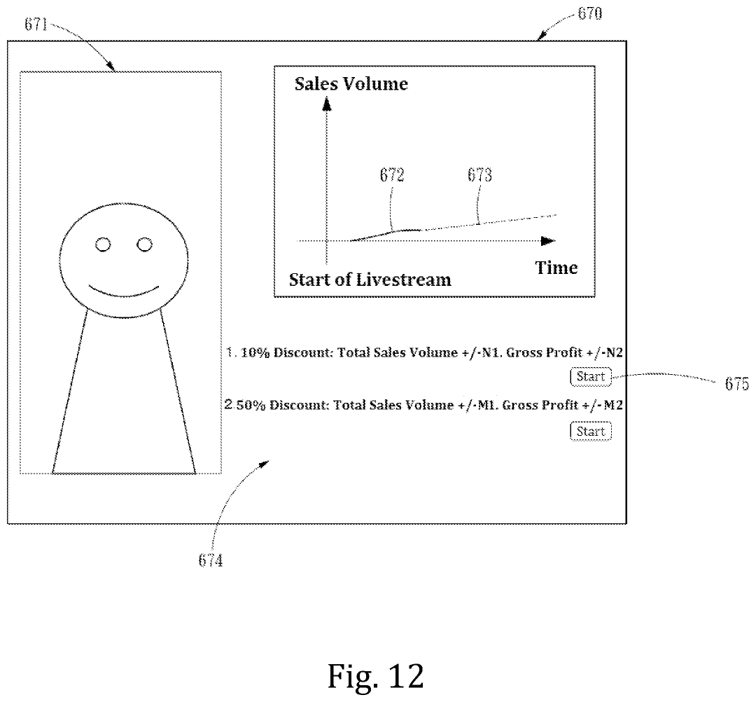

The projections for the plans in Table 4 are shown in FIG. 11. In FIG. 11, line A represents the case A, line B represents the case B, and line C represents the case C. Returning to FIG. 9, in operation 92, the maximum sales profit case may be selected from among all the forecasts and provided to the livestreamer LV for his/her reference, or all the forecasts may be provided to the livestreamer LV for his/her reference. Or all the forecasts with the maximum sales profit case displayed as a recommended case may be provided to the livestreamer LV for his/her reference. In operation 93, the projected sales profit of the selected case and the projected sales profit of the case where no sales promotions are employed are provided to the livestreamer LV as advice. As shown in FIG. 12, a representative screen image 670 of the screen of the livestream on the display of the user terminal 20 of the livestreamer LV includes a screen 671 showing the livestream of the livestreamer LV, current sales data 672, projected sales data 673 (case where no sales promotions are adopted), and sales promotion activities 674 provided through the above method. The representative screen image 670 is an interface that provides buttons 675 to start the corresponding promotion activity, and when the livestreamer LV clicks one of the buttons, the livestreamer L starts to take the corresponding promotion activity (operation 94). For example, a machine learning model trained based on the history data determines that adopting a 10% discount increases sales volume by 10%, and the gross profit is (10+20×1.1)×(50×0.9−20)=800 yuan, i.e., the case B in Table 4 above.

The information processing device, information processing method, and storage medium storing a program of the disclosure optimize the sales results by predicting the sales of a selling item sold in the livestream based on the parameters relating to the livestream using a machine learning model, and by guiding the livestreamer who is demonstrating the selling item based on the predicted results to change his/her way to sell the item.

The information processing device herein such as the servers 10, 40 and 50 and user terminals 20 and 30 are each equipped with a processor, memory, an input interface for receiving user input, an output interface for outputting information, a communication interface, and any other components necessary to operate as the information processing device.

The processor is an operating device that loads an operating system and various programs into a memory unit and may execute commands or instructions included in the loaded programs. The processor is, for example, a CPU, an MPU, a DSP, a GPU, any other computing device, or a combination thereof. The processor may be a collection of multiple physically separate processors. In this specification, a program or instructions included in the program that are described as being executed by the processor may be executed by a single processor or executed by a plurality of processors in a distributed manner. Further, a program or instructions included in the program executed by the processor may be executed by one or more virtual processors.

The information processing device may include a storage. The storage is an external storage device accessed by the processor. The storage is, for example, a magnetic disk, an optical disk, a semiconductor memory, or various other storage devices capable of storing data.

Programs executed by the processor can be stored on various types of non-transitory computer readable media, in addition to the storage. The non-transitory computer readable media include various types of tangible storage media. Examples of the non-transitory computer readable media include magnetic recording media (e.g., flexible disks, magnetic tape, hard disk drives), magneto-optical recording media (e.g., magneto-optical disks), compact disc read only memory (CD-ROM), CD-R, CD-R/W, and semiconductor memory (e.g., mask ROM, programmable ROM (PROM), erasable PROM (EPROM), flash ROM, random access memory (RAM)).

Even if the processes and the procedures described herein are executed by a single apparatus, software piece, component, or module, such processes and procedures may also be executed by a plurality of apparatuses, software pieces, components, and/or modules. Even if the data, tables, or databases described herein are stored in a single memory, such data, tables, or databases may also be stored distributively in a plurality of memories included in a single apparatus or in a plurality of memories arranged distributively in a plurality of apparatuses. Furthermore, the elements of the software and hardware described and illustrated herein may also be integrated into a smaller number of constituent elements or separated into a larger number of constituent elements.

The numbers and labels given to the elements in the appended claims should be construed in each context. The same numbers and labels do not necessarily denote the same elements among the contexts. The use of numbers to identify constituent elements does not prevent the constituent elements from performing the functions of the constituent elements identified by other numbers.

What is claimed is:

1. An information processing method, comprising:
via one or more computer processors,
receiving data relating to live sales performed by a livestreamer via live video streaming;
inputting the data into a machine learning model; and
based on a result generated by the machine learning model, obtaining promotional information that is useful for the livestreamer to perform the live sales.

2. The information processing method of claim 1, further comprising, after the obtaining the promotional information, delivering the promotional information to the livestreamer over a network.

3. The information processing method of claim 1, wherein the data includes at least one selected from the group consisting of: an attribute of a sold or unsold item, number of sold or unsold items, price of sold or unsold item, number of views, a viewer attribute, a viewer behavior score, a viewer behavior history, viewer metadata, service traffic, elapsed time, remaining time, and current time.

4. The information processing method of claim 1, wherein the promotional information includes a sales plan,
wherein the obtaining the promotional information includes generating the sales plan,
wherein the generating the sales plan includes:
obtaining a result of an assessment of the live sales performed by inputting the data into the machine learning model; and
retrieving the sales plan that corresponds to the result of the assessment from a library,
wherein the method further includes delivering the retrieved sales plan to the livestreamer.

5. The information processing method of claim 4, wherein the sales plan includes at least one selected from the group consisting of: a discount rate, an item discounted, number of discounted items, a duration of discount, time of discount, and a target that receives discount.

6. The information processing method of claim 1, further comprising:
after the providing the promotional information, determining whether a livestreamer's subsequent sales activity matches the promotional information; and
based on first sales data before the livestreamer receives the promotional information and second sales data after the livestreamer receives the promotional information, generating an assessment result for the promotional information or the machine learning model, including whether the sales activity matches the promotional information.

7. The information processing method of claim 1, wherein the promotional information is a future sales forecast generated based on an unchanged sales strategy.

8. The information processing method of claim 1, wherein the obtaining the promotional information includes generating the promotional information,
wherein the generating the promotional information includes:
inputting the data into the machine learning model to obtain two or more future sales plans and two or more sales forecasts corresponding to the two or more future sales plans; and
calculating the sales forecasts and obtaining two or more projected sales profits corresponding to the two or more sales plans,
wherein the method further includes providing an interface that allows the livestreamer to select one of the two or more future sales plans by delivering the two or more future sales plan and the two or more projected sales profits to the livestreamer.

9. The information processing method of claim 1, wherein the obtaining the promotional information includes generating the promotional information,
wherein the generating the promotional information includes:
obtaining an extent to which viewers are affected by a discount by inputting the data into the machine learning model; and
generating the promotional information depending on the extent.

10. An information processing device, comprising:
a processor; and
a storage adapted to store executable commands,
wherein during execution of the executable commands, the information processing device causes the processor to perform a step of:
receiving data relating to live sales performed by a livestreamer via live video streaming;
inputting the data into a machine learning model; and
based on a result generated by the machine learning model, obtaining promotional information that is useful for the livestreamer to perform the live sales.

11. A non-transitory computer-readable storage medium storing a program for causing one or more computer devices to perform the steps of:
receiving data relating to live sales performed by a livestreamer via live video streaming;
inputting the data into a machine learning model; and
based on a result generated by the machine learning model, obtaining promotional information that is useful for the livestreamer to perform the live sales.
